(19) United States
(12) Patent Application Publication
(10) Pub. No.: US 2017/0283288 A1
(43) Pub. Date: Oct. 5, 2017

(54) HEAT TRANSFER WASTEWATER TREATMENT SYSTEM

(71) Applicant: Kevin R. CHAFFEE, Batesville, IN (US)

(72) Inventor: Kevin R. CHAFFEE, Batesville, IN (US)

(21) Appl. No.: 15/626,889

(22) Filed: Jun. 19, 2017

Related U.S. Application Data
(63) Continuation-in-part of application No. PCT/US2015/067230, filed on Dec. 21, 2015.
(60) Provisional application No. 62/094,160, filed on Dec. 19, 2014.

(51) Int. Cl. C02F 3/08

(52) U.S. Cl. CPC C02F 3/08; C02F 2101/16

(57) ABSTRACT

A heat transfer wastewater treatment system utilizes the heat available in raw wastewater flowing into an outdoor treatment pond or other vessel of a wastewater treatment plant to increase the temperature of effluent that is drawn from the pond or other vessel and is provided to a nitrification vessel after warming, thereby improving ammonia reduction provided by the treatment plant, especially during the winter season. The system utilizes the environmentally sustainable green energy available in the raw influent to provide passive heat transfer for improved wastewater treatment.

### CROSS-REFERENCE TO RELATED APPLICATIONS

This application is a continuation-in-part of International Application No. PCT/US2015/067230, filed Dec. 21, 2015, and titled Heat Transfer Wastewater Treatment System; which claims the benefit of U.S. Provisional Patent Application 62/094,160, filed Dec. 19, 2014, and titled Heat Transfer Wastewater Treatment System; both of which are hereby entirely incorporated herein by reference.

### FIELD OF THE INVENTION

The present invention relates to wastewater treatment plants, and more specifically, to controlling wastewater process temperature for ammonia reduction.

### BACKGROUND

Many communities utilize wastewater stabilization ponds (hereinafter referred to as “ponds” or “lagoons”) as their wastewater treatment plant (hereinafter referred to as “WWTP”). Ponds provide reliable, low cost, and relatively low maintenance treatment of domestic wastewater. Ponds have been used for treatment of wastewater for over 3,000 years. The first recorded construction of a pond system in the U.S. was at San Antonio, Tex., in 1901. Today, over 8,000 wastewater treatment ponds are in place, involving more than 50% of the wastewater treatment facilities in the U.S. One drawback of wastewater treatment ponds is that it can be difficult to control or predict ammonia levels in effluent, particularly in cold environments, for example, during the winter season.

Ammonia (NH3) is a common toxicant derived from domestic water wastes, fertilizers, and natural processes. Ammonia nitrogen includes both the ionized form (ammonium, NH4+) and the unionized form (ammonia, NH3). An increase in pH favors formation of the more toxic unionized form (NH3), while a decrease favors the ionized (NH4+) form. Temperature also affects the toxicity of ammonia to aquatic life. Ammonia is a common cause of fish kills, but the most common problems associated with ammonia relate to elevated concentrations affecting fish growth, gill condition, organ weights, and hematocrit. Exposure duration and frequency strongly influence the severity of effects. Ammonia also exerts a biochemical oxygen demand on receiving waters because dissolved oxygen is consumed as bacteria and other microbes oxidize ammonia into nitrite and nitrate. The resulting dissolved oxygen reductions can decrease species diversity and even cause fish kills. Additionally, ammonia can lead to heavy plant growth due to its nutrient properties. Conversely, algae and macrophytes take up ammonia, thereby reducing aqueous concentrations.

During secondary wastewater treatment, biodegradable soluble organics are degraded through aerobic biological processes. Beneficial microorganisms (bacteria and protozoa) feed on the contaminants, increasing their population (biomass) as food and oxygen are supplied. Biochemical oxygen demand (BOD) indicates a high level of microbial activity and is used as a measure of wastewater strength; as organic contaminants are removed, BOD decreases. Ponds typically provide adequate BOD reduction, wastewater solids elimination and pathogen destruction.

Nitrifying bacteria also provide ammonia reduction when wastewater temperatures are warm. However, ponds generally do not provide ammonia reduction when water temperatures drop. Nitrification slows and limited ammonia is removed when temperatures drop below about 40° F. In an effort to promote water quality and wildlife, the EPA and individual states are beginning to impose ammonia limits for water discharged from WWTPs into waterways; summer limits are typically 1.5 milligrams per liter, but can be as low as 1 milligram per liter, and winter limits may be as high as 5 to 7 milligrams per liter. Ammonia limits are also based on other factors, for example, the size of the body of water into which the treatment process discharges or specific wildlife concerns. Although some regulatory agencies have imposed relaxed winter ammonia limits, a cost-effective ammonia removal solution is still needed to allow pond-based WWTP's to meet these requirements, especially during seasonally cold conditions.

As more pond-based WWTP's are being mandated to meet year-round, stringent ammonia limits, many of these communities are being forced to replace their ponds with new mechanical WWTPs. The cost of a new WWTP is overwhelming for many communities with ponds. Most of these communities are smaller entities without the resources to fund a major public works project. New mechanical WWTPs also require substantially greater resources to operate and maintain compared to ponds.

Other methods of reducing ammonia from pond-based systems include converting the pond to an activated sludge (hereinafter referred to as “AS”) or modified AS process. Even though the pond is not replaced, the costs to convert the pond to an AS system and operate it are excessive for many communities. In the more-expensive, suspended-growth systems, such as AS processes, the waste flows around and through the free-floating microorganisms, gathering into biological flocs that settle out of the wastewater. The settled flocs retain the microorganisms, meaning they can be recycled for further treatment. In an activated sludge process, air is blown into a tank filled with wastewater and a suspended biomass consumes the organic material as well as the ammonia. A benefit of the suspended growth process is that biological heat is generated from growing the biomass in the system. However, although suspended growth tanks are typically buried or partially buried, they are typically open at the top due to the prohibitive costs of covering the tanks, and are thus potentially subject to reduced effectiveness in lowering ammonia levels during winter months. However, the heat of the activated sludge process typically keeps the wastewater temperatures high enough for nitrification and ammonia reduction if the process is sufficiently insulated from cold ambient temperatures.

Other options for improving pond-based WWTP ammonia reduction include add-on attached-growth processes such as trickling filters, constructed wetlands, and moving bed biofilm reactors (MBBRs). These attached-growth processes typically work well if the influent water temperature is high enough to maintain nitrification. The trickling filter consists of a fixed bed of gravel, peat moss, ceramic, plastic, or textile media, over which wastewater passes and creates a biofilm that becomes thick and falls off. MBBRs consist of polyethylene biofilm carriers operating in mixed motion within an aerated wastewater treatment basin. Each individual biocarrier increases productivity through providing protected surface area to support the growth of heterotrophic and autotrophic bacteria within its cells. In order to provide high enough water temperatures for attached-growth systems to perform nitrification, the process must either take place within an expensive greenhouse or costly energy must be expended to heat the wastewater to a temperature above 40 degrees Fahrenheit, because nitrification declines rapidly below 40 degrees Fahrenheit.

Another attached growth system solution, a submerged attached growth reactor (SAGR), consists of an underground, varied rock filter. The system includes a deep hole in the ground, into which air piping is laid and covered with gravel. The entire system is covered and lagoon influent is brought upwards from the bottom through the gravel and attached growth treatment process. The system relies on built up heat and geothermally stabilized heat to maintain sufficient temperatures for nitrification, but such a system is still subject to heat dissipation, potentially becoming too cold for nitrification to take place in cold environments, including harsh, long winters.

Therefore, the need exists for a cost-effective process to improve nitrification of stabilization pond effluent in cold climates without converting the WWTP to a new process, or abandoning the pond.

### SUMMARY

In one aspect, a heat transfer wastewater treatment system utilizes the heat available in raw wastewater flowing into an outdoor treatment pond or other vessel of a wastewater treatment plant to increase the temperature of effluent that is drawn from the pond or other vessel and is provided to a nitrification vessel after warming, thereby improving ammonia reduction provided by the treatment plant, especially during the winter season. The system utilizes the environmentally sustainable green energy available in the raw influent to provide passive heat transfer for improved wastewater treatment.

The claimed system will work for any attached growth wastewater treatment nitrification process, including MBBRs, trickling filters, and rotating biological contactors. Although the claimed system is of particular benefit to lagoon wastewater treatment system because they do not have enough biomass to generate the heat necessary for nitrification, the claimed system could be applicable to any older process that was not designed to nitrify or to sufficiently nitrify effluent. The addition of a nitrification process to such systems requires addressing the issue of cold temperatures in the winter months that cool wastewater while it is held in a treatment vessel that is exposed to cold outdoor temperatures. There are also industrial processes that include lagoons for wastewater treatment. The present invention is not necessarily limited to domestic or municipal wastewater, but can provide a cost-effective solution for any industrial wastewater treatment system where there is a need to increase effluent temperature for nitrification.

Package activated sludge plants can also run into problems if the plant was not originally designed to reduce ammonia because there were no ammonia effluent discharge limits at the time of design. Such existing processes may consider putting an attached growth nitrification process such as an MBBR in behind them. Also, wastewater treatment for industrial processes, e.g. large steel plants, sit above grade and may have cold temperature issues; the claimed process could be applicable to be used on existing plants that are having trouble nitrifying, including to meet applicable lowered ammonia discharge levels.

The present invention may comprise one or more of the features recited in the attached claims, and/or one or more of the following features and combinations thereof.

The present wastewater treatment system for treating a raw influent, includes a wastewater influent vessel that receives influent at a first temperature, a wastewater treatment vessel coupled to the influent vessel that receives the raw influent at a second temperature, a treated wastewater effluent vessel coupled to the treatment vessel that receives treated effluent drawn from the treatment vessel at a third, lower than the second, temperature, a heat exchanger that thermally couples the influent vessel and the effluent vessel so that heat is transferred from the raw influent to the treated effluent, raising the temperature of the treated effluent from the third temperature to a fourth temperature, and a nitrification vessel that receives the warmed treated effluent from the heat exchanger.

The wastewater treatment vessel of the present invention may be a lagoon, a basin, or other vessel that typically could be expose the wastewater to cool or cold winter temperatures, for example, below 40 degrees Fahrenheit.

An illustrative wastewater treatment system according to the present invention can utilize a pump to draw the treated effluent from the wastewater treatment vessel and into the effluent vessel for warming by the heat exchanger prior to nitrification in the nitrification vessel.

A pump speed controller can be used to control the flow of treated effluent from the wastewater treatment vessel and a flow meter can be used to measure the flow of raw influent.

The heat exchanger of the present invention can be formed by at least a length of the influent vessel extending coaxially through at least a length of the effluent vessel, such that heat is transferred from the warmer raw influent to the colder treated effluent drawn from the treatment vessel.

The influent vessel of the present invention can be a first pipe and the effluent vessel can be a second pipe having a larger diameter than the first pipe, so that at least a section of the first pipe is located coaxially within at least a section of the second pipe, thereby transferring heat from the raw influent to the treated effluent drawn from the treatment vessel.

The heat exchanger of the present invention can further include two or more parallel routes of influent pipe in thermal communication with a carrier treated effluent pipe.

A wastewater treatment system according to the present invention can utilize a heat exchanger where at least a length of the effluent vessel extends coaxially through at least a length of the influent vessel, such that heat is transferred from the raw influent to the treated effluent drawn from the treatment vessel.

The wastewater vessel of the present invention can degrade biodegradable soluble organics through aerobic biological processes.

The treatment vessel of the present invention can be exposed to the outdoor ambient air temperature.

The nitrification vessel of the present invention can be a moving bed biofilm reactor.

In accordance with the present invention the raw influent can be at least one of a pumped and gravity-fed main line to the influent vessel.

The fourth temperature can be equal to or greater than 40 degrees Fahrenheit according to the present invention.

The wastewater treatment system of the present invention can include at least one of an influent and an effluent bypass of the heat exchanger.

A process for treating wastewater according to the present invention can include the steps of introducing raw influent into an influent vessel at a first temperature, passing the influent to a treatment vessel at a second temperature, withdrawing a treated effluent from the treatment vessel at a third temperature that is colder than the second temperature, passing the treated effluent in a heat exchange relationship with the influent to effectuate heating of the treated effluent to a fourth temperature sufficient for nitrification; and introducing the heated treated effluent into a nitrification vessel.

According to the present invention, the process for treating wastewater can also include the steps of measuring the rate of flow of raw influent into the influent vessel and controlling the rate of flow of treated effluent withdrawn from the treatment vessel to match the rate of flow of the raw influent.

An illustrative process according to the present invention can also include the steps of measuring the fourth temperature of the effluent and controlling the rate of flow of treated effluent withdrawn from the treatment vessel to maintain the fourth temperature at or above 40 degrees Fahrenheit.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 is a flow schematic and block diagram depicting an exemplary embodiment of the wastewater treatment system and process, according to the present disclosure;

FIG. 2 is an elevation view in partial section of the wastewater treatment process of FIG. 1, where a gravity wastewater line is coming into the lagoon;

FIG. 3 is an elevation view in partial section of the wastewater treatment process of FIG. 1, where a forced, or pumped, main wastewater line is coming into the lagoon;

FIGS. 4a and 4b are a side and end view, respectively, of the heat exchanger device of the previous Figs.

### DESCRIPTION OF THE ILLUSTRATIVE EMBODIMENTS

For the purposes of promoting and understanding the principals of the invention, reference will now be made to one or more illustrative embodiments illustrated in the drawings and specific language will be used to describe the same.

A vessel is defined herein to be a container for liquid, e.g. a basin or tank, or a carrier for liquid, e.g. a pipe or other conveyance, or a combined carrier and container, e.g. a manhole.

A pond is defined herein to be a structure to contain and facilitate the process of treating or stabilizing wastewater, e.g. a lagoon, cell, or basin.

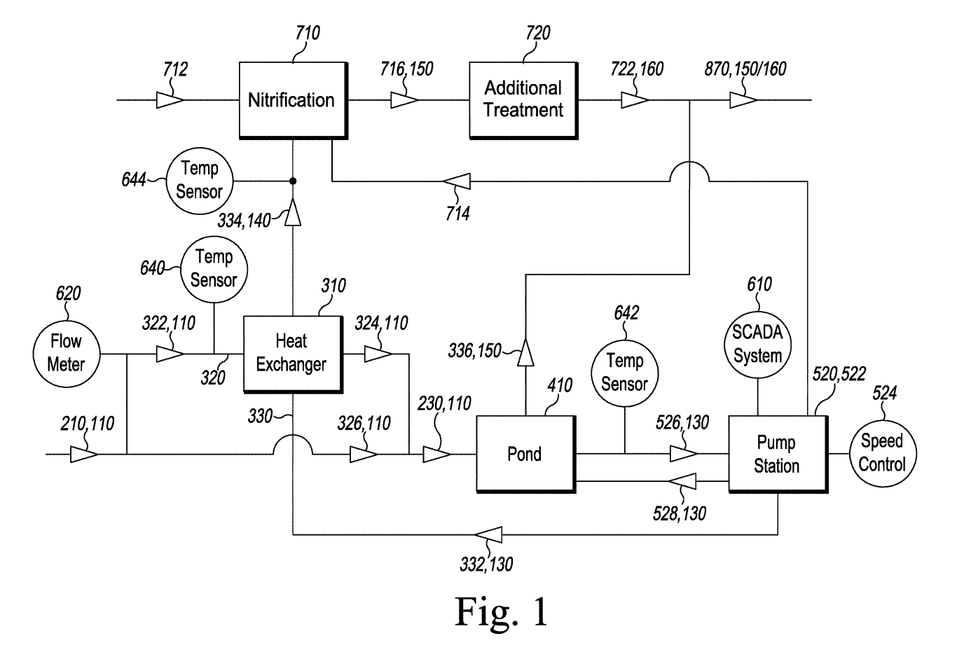

Referring to FIGS. 1, 2, 4a and 4b, there is shown a first wastewater treatment process and system, according to the present disclosure. Raw influent wastewater 110 from the community enters the WWTP in the influent sewer line 210. The temperature of this influent wastewater 110, also referred to as a first temperature, generally ranges from about 50° to 75° F. depending on factors such as the climate, time of year, wastewater source and amount of infiltration/inflow. The influent wastewater is directed into an upper influent manhole 220. The outlet of the manhole contains the tee junction of the heat exchanger influent feed line 322 and the influent heat exchanger bypass line 326, which may be a pre-existing portion of the WWTP.

The heat exchanger 310 consists of a wastewater influent vessel, for example an influent line 320, for example a watertight inner sewage carrier pipe 312, and a treated wastewater effluent vessel, for example an effluent line 330, for example, a surrounding watertight casing pipe 314, which can be insulated with pipe insulation 316. The heat exchanger inlet is installed inside the upper influent manhole 220 with the top of the carrier pipe 312 being lower than the invert of the influent sewer line 210. This allows the carrier pipe 312 to flow fully filled with raw influent 110, thereby maximizing the amount of heat transfer available. The carrier pipe 312 may be made of metal, for example copper, to maximize heat transfer therethrough. In a particular embodiment a 4″ type K copper pipe is used to carry the influent wastewater 110 since it has excellent heat transfer properties and is readily available.

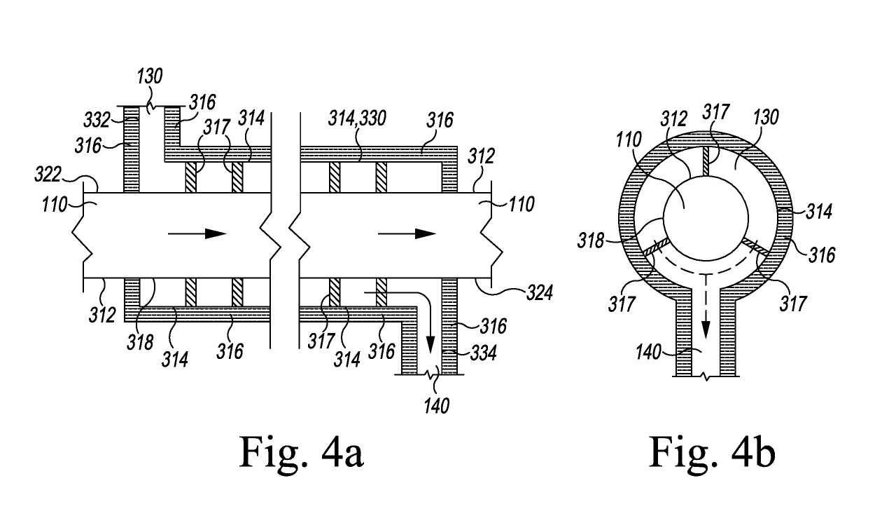

Referring to FIGS. 4a and 4b, casing pipe 314 is larger and surrounds the carrier pipe 312 and is sealed around the carrier pipe 312 at both ends to form an enclosed vessel. The casing pipe 314 may be made of any material, for example plastic or polyethylene, to minimize heat loss through its outer walls and into the soil. The casing pipe may be insulated with pipe insulation 316 to prevent heat loss into the surrounding soil. In a particular embodiment, an 8″ DR 11 HDPE pipe is used for the carrier pipe to provide the proper velocity of the lagoon-treated effluent 130 to flow through the pipe, while minimizing headloss and keeping the pumps as small and energy efficient as possible.

Referring to FIGS. 4a and 4b, optionally, one or more support legs 317, also referred to as support members, may be coupled to an outer surface 318 of the carrier pipe 312 to add support to carrier pipe 312 inside surrounding watertight casing pipe 314. The support legs 317 may also serve to increase the surface area for heat transfer from the raw influent wastewater 110 to treated effluent 130. An illustrative embodiment of the support legs 317 may include copper members, e.g., three or more copper members spaced around the diameter of carrier pipe 312 which may be soldered to the outer surface 318 of the carrier pipe. The copper legs provide support to the carrier pipe 312 against the inner surface of the surrounding watertight casing pipe 314, and transfers heat to the treated effluent 130 flowing into heat exchanger 310. It is desirable that the support legs 317 be of sufficient size and strength to support the weight of carrier pipe 312 and influent wastewater 110, promote heat exchange, but also minimize the likelihood of debris from treated effluent 130 catching on the support legs 317. In that regard, the cross-section (not shown) of support legs 317 may be circular, elongated along the direction of flow of effluent 130, or another geometric shape that provides the required strength, heat transfer, and minimal obstruction that may catch debris. Additionally, the support legs may be locate around the diameter of carrier pipe 312 to avoid the lowest portion of the treated effluent 130 where solid debris will most likely flow, for example, located at the 12, 4, and 8 o'clock positions as illustrated in FIG. 4b.

The heat exchanger effluent line 300, also referred to as an effluent vessel, may be, for example, casing pipe 314, and is connected using watertight connections to the heat exchanger effluent feed line 332 and the heat exchanger effluent discharge line 334. The connections are at opposite ends of the heat exchanger 310. The casing pipe 314 may be insulated with pipe insulation 316 to prevent heat loss into the surrounding soil.

The length of the heat exchanger pipe is determined by the daily flow volume into the system, the sewage influent first temperature, the lagoon-treated effluent third temperature, the desired lagoon effluent fourth temperature to support nitrification, the type of carrier pipe used (the more conductive of heat the better) in the heat exchanger, the diameter of the carrier and casing pipes, and a selected heat exchanger fouling factor. Using this information, a total length of pipe for the heat exchanger is calculated which may be provided as a single run, or multiple runs with elbows at the ends and forming parallel lines. For example, multiple runs could be made in a parallel type system utilizing 90-degree pipe fittings.

A series of calculations are used to determine heat exchanger sizing for lagoon effluent heating. First, the heat transfer area needed is estimated by utilizing the following equations: q=±(m₁)(Cₚ₁)(T₁ᵢₙ−T₁ₒᵤₜ); q=±(m₂)(Cₚ₂)(T₂ᵢₙ−T₂ₒᵤₜ); ΔTₗₘ=[(T₁ᵢₙ−T₂ₒᵤₜ)−(T₁ₒᵤₜ−T₂ᵢₙ)]/ln[(T₁ᵢₙ−T₂ₒᵤₜ)/(T₁ₒᵤₜ−T₂ᵢₙ)]; and q=UAΔTₗₘ; where q is the heat transfer rate, m is the mass flow rate, c is specific heat, T is temperature, U is the overall heat transfer coefficient estimate, and A is the heat transfer area. Secondly, the pipe length needed for the calculated heat transfer area is determined using the following equations: D=Dᵢₙ/12; A=πDL; and L=A/πD; where D is the pipe diameter, A is the heat transfer area, and L is the pipe length needed. If necessary, the number of passes and pipe length per pass is determined using the following equations: Lₚ=L/Nₚ and N_{B}=Nₚ−1, where Lₚ is the length per pass, L is the pipe length needed, and N_{B} is the number of 180-degree bends.

In a particular embodiment, the design flow is about 80,000 gallons per day with an assumed raw influent first temperature of 50 degrees Fahrenheit. It is further assumed the lowest temperature of wastewater coming out of the lagoon, the treated effluent third temperature, was at 32 degrees Fahrenheit and 16 milligrams ammonia per liter. Given that at temperatures less than 40 degrees Fahrenheit, nitrifying bacteria become dormant or inactive, the goal is to raise the treated effluent temperature to a target minimum fourth temperature of 41 degrees Fahrenheit in order to promote nitrification and ammonia reduction to less than 3 milligrams ammonia per liter, satisfying the regulatory requirement of 5 milligrams ammonia per liter. It was calculated that the raw influent coming out of the heat exchanger and discharged into the lagoon was cooled to a second temperature of 41.1 degrees Fahrenheit. Further, the municipality of this embodiment had a 4-inch force main coming into the lagoon, all of the municipality's waste water being collected in the town and pumped to the lagoon, as is fairly common practice. To raise the temperature to the target of 41-degrees Fahrenheit, 303 lineal feet of carrier casing pipe is placed around the 4 inch influent pipe. The heat exchange between the raw wastewater influent and pond effluent is sufficient to thereby increase the fourth temperature of the pond effluent to 41 degrees Fahrenheit and promote nitrification of the pond effluent. Also, the size of the MBBR or other nitrification system behind the heat exchanger in the process to actually nitrify the pond effluent is determined based on the minimum temperature of 41 degrees. Smaller nitrification tanks and/or reduced MBBR media, and therefore reduced costs, can be used for warmer target fourth temperatures.

In a particular embodiment, the design wastewater flow rate in and out of the lagoon (Q_{ww}) equals 80,000 gpd (gallons per day) or 0.080 MGD (million gallons per day). The raw influent first temperature (T_{inf1}) equals 50 degrees Fahrenheit and the lagoon effluent third temperature T_{eff1} is assumed worst case to be 32 degrees Fahrenheit. The target MBBR influent temperature (T_{effl2}) was selected to be 41 degrees Fahrenheit or 5.0 degrees Celsius. The wastewater specific heat (C_{pww}) equals 1.0 Btu/lb-° F. and the wastewater specific gravity (SG_{ww}) equals 1.0. The overall heat transfer coefficient estimate (u*) equals 87.0 Btu/hr-ft²-° F. Thus the lagoon influent/effluent mass flow rate (m_{ww}) equals 8.34*SG_{ww}*Q_{ww}*1000000/24, or 27.800 lb/hr. The heat transfer rate (q) equals m_{ww}*C_{pww}*(T_{effl2}−T_{effl1}), or 250.200 Btu/hr. The cooled lagoon influent second temperature (T_{inf2}) (influent flowing out of the heat exchanger and into the lagoon) equals T_{inf1}−(T_{effl2}−T_{effl1})+0.1, or 41.1° F. The log mean temperature difference (ΔTₗₘ.) equals ((T_{infl1}−T_{effl2})−(T_{inf2}−T_{effl1}))/(LN(T_{inf1}−T_{effl2})/(T_{inf2}−T_{effl1}))), or 9.05° F. Thus the required heat transfer area (A) equals q/(U**ΔTₗₘ), or 317.78 ft². The influent wastewater pipe diameter equals (Din) 4 inches or 0.3333 feet. The pipe length needed (L) equals A/(π*D) or 303 feet. Only one pass was selected (N_{P}*) and therefore the length of the pass (L_{P}) was also 303 feet, with 0 180° bends (N_{B}).

The interstitial space between the casing pipe 314 and the carrier pipe 312 (FIGS. 4a and 4b) is sized to maintain a certain flow velocity to maximize heat exchange, for example, 3 to 6 feet per second, and to minimize pumping and energy usage.

The influent wastewater 110 flows along the length of the heat exchanger carrier pipe 312 and is discharged into lower influent manhole 222, flows through the manhole 222 and enters the heat exchanger influent discharge line 324. The elevation of the heat exchanger influent discharge line 324 invert is above the top of the carrier pipe 312 to allow the carrier pipe 312 to flow full for maximum heat transfer. The wastewater then flows into the pond influent line 230 and ultimately to the pond 410 or other treatment vessel, where biological and physical treatment occurs. Treatment in the pond includes normal wastewater biological and chemical processes where the BOD, total suspended solids, and pathogens are reduced.

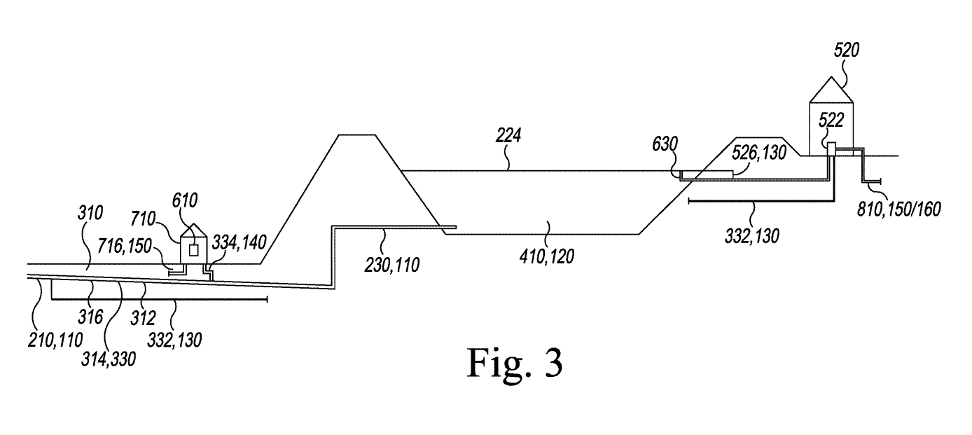

Pond influent 110 may be gravity-flow, as described above, or referring to the embodiment illustrated in FIG. 3, the influent 110 may be pumped through a force main to the pond 410. If the influent 110 is not pumped through a force main and the influent sewer line 210 is at a lower elevation than the pond 410, the WWTP may utilize an influent pump (not shown) located at an influent pump station (not shown) to pump the raw influent sewage 110 into the pond 410 instead of gravity or a force main. For such an application, the heat exchanger 310 could be installed on the sewer line leading into the pumping station (not shown) lifting the influent wastewater 110 into the pond 410. Alternatively, the influent wastewater pump station (not shown) could pump the influent raw sewage 110 through the heat exchanger 310 with the pond effluent 130 either flowing by gravity or being pumped through the heat exchanger 310 by effluent pump 522 located at effluent pump station 520.

As illustrated in FIG. 1, the heat exchanger 310 would normally be installed as a parallel line to the existing force main 326, keeping the force main as a bypass line during summer months when it is not needed or when the heat exchanger is being serviced. Two tees would be placed in the lagoon influent line 326 with valves to allow the flow to go either directly into the pond (bypass mode) or be directed into the heat exchanger 310. The pond influent 110 would flow through the heat exchanger 310, then be discharged into the heat exchanger influent discharge line 324, and then back into the pond influent line 230 and directed to the pond 410. Given that the existing force main 210 would typically be made of either ductal iron pipe or plastic pipe, both of which are bad conductors of heat, the material type of the parallel heat exchanger line 312 can also be changed to a better heat exchange material, such as copper.

Low-temperature, treated effluent 130 from pond 410 is pulled from the pond 410 by effluent pump 522 and discharged into the heat exchanger effluent feed line 332. The raw influent flow 110 is measured by the flow meter 620 and the flow rate is sent to the SCADA system 610 which controls effluent pump speed controller 524 which is typically a variable speed drive (VFD). The effluent pump speed controller 524 changes the speed of the effluent pump 522 so that the treated effluent 130 from the pond 410 is regulated to not exceed the average influent flow to balance the potential heat transfer. The desired operation would be to match the heat exchanger wastewater influent 110 flow with the pond treated effluent 130 flow through the heat exchanger since the temperature of the pond effluent 130 will be raised by the temperature of the raw sewage influent 110.

During summer months or when the system is being serviced, heat exchanger effluent bypass line 336 allows the pond effluent to be discharged without being sent through the heat exchanger system. Additionally, nitrification 710 may also be bypassed.

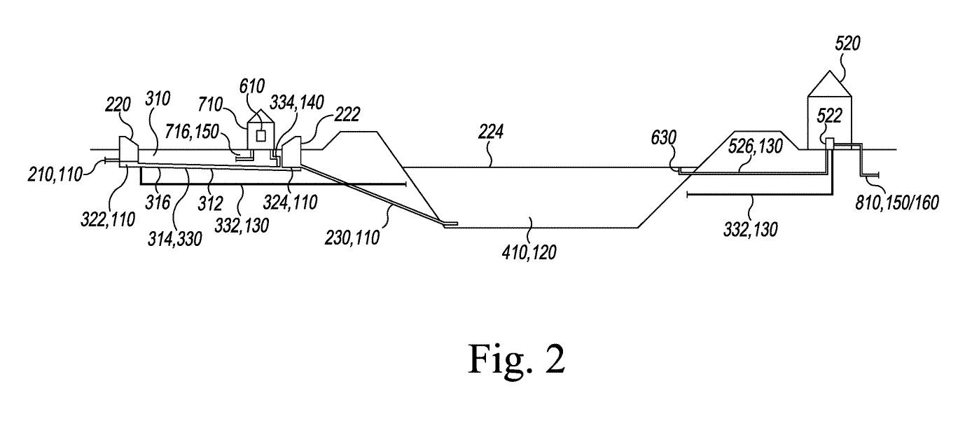

Low-temperature, treated effluent 130 from pond 410 may flow through a flow-controlling device 630 (FIGS. 2 and 3), which may be an orifice, slide gate or weir. The flow control device 630 may be sized so that the effluent 130 from the pond 410 is regulated to not exceed the average influent flow 110 to maximize the potential heat transfer.

Treated effluent 130 flows from the flow controller 630 through the effluent pump station influent line 526 into effluent pump station 520. Treated effluent 130 is stored in pump station 520 and is pumped by effluent pump 522 through heat exchanger feed line 332 to the inlet end of the carrier pipe 312. The pump flow rate is sized to match the average influent sewer flow rate so that the rate of heat transfer is balanced. It is also beneficial to the heat exchanger 310 if the pipes are kept full, thereby maximizing heat transfer. The speed and output of this pump 522 may be varied to match influent flow rates into the pond 410. During summer months or when the system is being serviced, effluent bypass line 336 allows the pond effluent 130 to be discharged without being sent through the heat exchanger 310.

The treated effluent 130 flows from the heat exchanger feed line 332 through the interstitial space between the carrier and casing pipes 312, 314 to the heat exchanger discharge line connection 334. Heat is transferred through the wall of the influent carrier pipe 312 into the treated effluent 130 as it flows around and along the effluent casing pipe 314. Treated effluent 130 is used for direct heat transfer to reduce heat losses if using glycol or other secondary heat transfer fluids, and to limit the number of heat exchangers required in the invention.

The warmed, treated effluent 140 enters the insulated discharge line 334 and is directed to a nitrification process 710. The nitrification process 710 may be a rock filter, constructed wetland, moving bed biofilm reactor (MBBR), or other process known to one of ordinary skill in the art for nitrifying ammonia. The nitrification process 710 is an MBBR in the exemplary embodiment and reduces ammonia levels in the treated effluent since the temperature of the warmed pond effluent 140, the fourth temperature, is high enough to allow the nitrifying bacteria to grow and survive. The nitrified effluent 150 may be directed to an additional treatment process 720, beneficial reuse, or disposal, for example, by discharging into a waterway. In instances where tight suspended solids limits are imposed, additional treatment process 720 may include a final filtration to remove any excess solids that may have sloughed off the MBBR median, such as a clarifier DAF. In a particular embodiment, a chemical is added to the MBBR to solidify phosphorous. A post-MBBR separation process such as a clarifier or DAF unit is then used to allow the solids to settle out, removing the phosphorus from the treated effluent.

A wastewater treatment process and system according to the present invention may include a supervisory control and data acquisition (SCADA) system 610 with temperature sensors 640, 642, and 644 at specified locations in the system as shown in FIG. 1. The temperature sensors 640, 642, and 644 measure wastewater temperature and transfer the data to the SCADA system 610. The SCADA system 610 can also monitor the influent flow rate from the flow meter 620 and allows the operator to choose how much heat is transferred, for example, by selecting a setpoint for the percentage of flow removed from the pond to be transferred to the heat exchanger 310. If more flow is removed than comes in, for example 125%, the temperature of the treated effluent 140 will be raised less than if incoming and outgoing flow rates are matched. This would allow less heat to be transferred if not required for nitrification or allow the pond level to be dropped if needed. If a setpoint of 100% is selected, the SCADA system 610 will direct the VFD 524 to control the pump speed to match the influent flow rate and maintain the maximum heat transfer. Ponds 410 generally also have built in free-board or storage. In a rain storm, more water may come into the pond 410 than what would typically be discharged. The pond's free-board or storage is then used to balance the influent and the outflow. Under such circumstances, the water level in the pond becomes a factor in controlling the flow rate of treated effluent through the heat exchanger.

Ammonia levels can also be measured with an automated sensor. If ammonia limits in the pond 410 are met, for example in the summer time, energy and cost can be saved by bypassing the separate nitrification process 710. If the nitrification process 710 has been bypassed for an extended period of time, it is necessary to establish nitrifying bacteria in the attached growth process for nitrification to occur again.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the claims and summary are desired to be protected. For example, alternative embodiments may utilize other forms of heat exchange, including an intermediate heat exchange medium or adding heat from an external source.

1. A wastewater treatment system for treating a raw influent, comprising:
a wastewater influent vessel receiving the raw influent at a first temperature;
a wastewater treatment vessel coupled to the influent vessel and receiving the raw influent at a second temperature;
a treated wastewater effluent vessel coupled to the treatment vessel and receiving treated effluent drawn from the treatment vessel at a third temperature that is lower than the second temperature;
a heat exchanger thermally coupling the influent vessel and the effluent vessel to transfer heat from raw influent and to the treated effluent, thereby raising the temperature of the treated effluent from the third temperature to a fourth temperature; and
a nitrification vessel receiving the warmed treated effluent from the heat exchanger.

2. The wastewater treatment system of claim 1, wherein the wastewater treatment vessel is a lagoon.

3. The wastewater treatment system of claim 1, further comprising a pump to draw the treated effluent from the wastewater treatment vessel and into the effluent vessel for warming by the heat exchanger prior to nitrification in the nitrification vessel.

4. The wastewater treatment system of claim 3, further comprising:
a flow meter to measure the flow of raw influent; and,
a pump speed controller to control the flow of treated effluent from the wastewater treatment vessel to equal the flow of raw influent.

5. The wastewater treatment system of claim 1, wherein the heat exchanger is formed by at least a length of the influent vessel extending coaxially through at least a length of the effluent vessel, thereby transferring heat from the raw influent and to the treated effluent drawn from the treatment vessel.

6. The wastewater treatment system of claim 5, further comprising at least one support member extending between the influent vessel and the effluent vessel.

7. The wastewater treatment system of claim 6, wherein the at least one support member are formed from metal, thereby providing heat transfer from the raw influent to the treated effluent.

8. The wastewater treatment system of claim 1, wherein the influent vessel comprises a first pipe and the effluent vessel comprises a second pipe having a larger diameter than the first pipe, at least a section of the first pipe located coaxially within at least a section of the second pipe, thereby forming the heat exchanger for transferring heat from the raw influent to the treated effluent drawn from the treatment vessel.

9. The wastewater treatment system of claim 1, wherein
the influent vessel includes a sewage carrier pipe;
the effluent vessel includes an effluent casing pipe; and
the heat exchanger further comprises two or more parallel routes of sewage carrier pipe in thermal communication with a treated effluent casing pipe.

10. The wastewater treatment system of claim 1, wherein the heat exchanger is formed by at least a length of the effluent vessel extending coaxially through at least a length of the influent vessel, thereby transferring heat from the raw influent and to the treated effluent drawn from the treatment vessel.

11. The wastewater treatment system of claim 1, wherein the wastewater treatment vessel degrades biodegradable soluble organics through aerobic biological processes.

12. The wastewater treatment system of claim 9, wherein the wastewater treatment vessel is exposed to the outdoor ambient temperature.

13. The wastewater treatment system of claim 1, wherein the nitrification vessel is a moving bed biofilm reactor.

14. The wastewater treatment system of claim 1, wherein the raw influent is pumped to the influent vessel.

15. The wastewater treatment system of claim 1, wherein the raw influent is gravity-fed to the influent vessel.

16. The wastewater treatment system of claim 1 wherein the fourth temperature is equal to or greater than 40 degrees Fahrenheit.

17. The wastewater treatment system of claim 1, further comprising a raw influent bypass line coupled to the wastewater treatment vessel and providing selective bypass of the heat exchanger.

18. The wastewater treatment system of claim 1, further comprising an effluent bypass of the heat exchanger.

19. The wastewater treatment system of claim 1, wherein the wastewater treatment vessel is a basin.

20. A process for treating wastewater, said process comprising the steps of:
(a) introducing raw influent into an influent vessel at a first temperature;
(b) passing the influent to a treatment vessel at a second temperature;
(c) withdrawing a treated effluent from the treatment vessel at a third temperature that is colder than the second temperature;
(d) passing the treated effluent in a heat exchange relationship with the influent to effectuate heating of the treated effluent to a fourth temperature sufficient for nitrification; and
(e) introducing the heated treated effluent into a nitrification vessel.

21. The process for treating wastewater of claim 18, further comprising the steps of:
(a) measuring the rate of flow of raw influent into the influent vessel; and
(b) controlling the rate of flow of treated effluent withdrawn from the treatment vessel to match the rate of flow of raw influent.

22. The process of treating wastewater of claim 18, further comprising the steps of:
(a) measuring the fourth temperature of treated influent; and
(b) controlling the rate of flow of treated effluent withdrawn from the treatment vessel to maintain the fourth temperature at or above 40 degrees Fahrenheit.
